(19) United States
(12) Patent Application Publication
(10) Pub. No.: US 2016/0266594 A1
(43) Pub. Date: Sep. 15, 2016

(54) SYSTEM AND METHOD FOR RESIDENTIAL UTILITY MONITORING AND IMPROVEMENT OF ENERGY EFFICIENCY

(71) Applicants: Daniel Kauffman, Cary, NC (US); Sebastian Morgan, Bothell, WA (US)

(72) Inventors: Daniel Kauffman, Cary, NC (US); Sebastian Morgan, Bothell, WA (US)

(21) Appl. No.: 15/066,023

(22) Filed: Mar. 10, 2016

Related U.S. Application Data
(60) Provisional application No. 62/132,470, filed on Mar. 12, 2015.

(51) Int. Cl. G05F 1/66; G05B 15/02

(52) U.S. Cl. CPC G05F 1/66; G05B 15/02

(57) ABSTRACT

A system and method of determining energy inefficiency of a dwelling comprising obtaining energy data, obtaining weather data, calculating at least one energy metric for the dwelling, and ranking multiple dwellings based on the at least one energy metric. The ranking of the dwelling indicates a source of energy inefficiency of the dwelling and can provide a recommendation to improve the energy efficiency of the dwelling.

### CROSS-REFERENCE TO RELATED APPLICATION

This application is a Utility patent application based on a previously filed U.S. Provisional patent application, U.S. Ser. No. 62/132,470 filed on Mar. 12, 2015, the benefit of the filing date is hereby claimed under 35 U.S.C. §119(e) and incorporated herein by reference.

### FIELD OF THE INVENTION

The present invention pertains to a system and method for residential utility monitoring and reduction of energy consumption. More particularly, the present invention pertains to a system and method for calculating an energy use profile for a dwelling from data obtained from an energy meter and a weather meter.

### BACKGROUND

The United States has over 130 million housing units, and almost all of these dwellings have electricity service provided. Electricity service to U.S. housing units is provided by one of nearly 3300 electricity providers, over 2000 of which are publicly owned utilities and a further 800-plus are electric cooperatives. Electricity is used for home heating and cooling, as well as for powering appliances and devices such as lights, refrigerators, cooling appliances, electronics, charging electric vehicles, and other residential uses.

Electric utility bills are usually charged to households on a monthly basis. Utility companies retain monthly bills of their residential customers' usage and charges for purposes including regulatory compliance, customer complaint resolution, debt collection, and capacity planning. Most electric utilities provide two years worth of billing history through online user accounts, and some even provide history through to the origin of the customer account at the present address.

In addition to electric service, over 60% of U.S. housing units receive metered natural gas service from one of over 1200 retail natural gas utilities. Similar to electric utilities, natural gas utilities charge households on a monthly basis, retain a history of past monthly bills, and many provide online access to these bills to their customers. Natural gas is used for home heating, water heating, cooking, and other uses.

Over 80% of U.S. homes are heated with either electricity or natural gas. Historically, heating and cooling have accounted for roughly half of energy consumption in U.S. housing units. As an alternative to retail natural gas services, many homes are serviced by delivery of an alternative fuel such as propane or fuel oil for heating and cooking. Many homes in the U.S. also have the ability to consume electrical energy generated on-site though the use of a generator, a combined heat and power system, solar panels, wind turbines, and other methods. Many homes are also heated or cooled through the use of geothermal heat pumps. Together, electricity service, natural gas service, propane and fuel oil use, geothermal heat pump use, and the consumption of electricity generated on-site including through solar panels and other means, constitute the energy consumed within U.S. housing units.

Utilities, governments, consumers, and other entities are seeking opportunities to decrease energy consumption and/or slow the rate of growth of energy consumption. At the residential consumer level, the cost of electricity and energy sources (such as natural gas and other fuels) provides an incentive to reduce energy consumption.

Metering systems can automatically measure and record energy consumption at regular intervals to allow for energy consumption data analysis, and such analysis can be used to understand and quantify energy usage and waste. For example, analysis of metering data can show how much energy is being used at different times of day, on different days of the week, or at different times of the year. Using the interval data, it is possible to determine how much energy is being consumed at different times and therefore to broadly identify the sources of energy usage. Many residential consumers stand to benefit from taking advantage of available energy meter data to obtain energy usage information about their home for the purpose of reducing energy consumption.

Energy savings can be measured by analyzing energy meter data and weather data before and after an upgrade in order to determine how well the energy-saving efforts have performed. Measurement of energy savings can further involve creating two whole-building energy use models of the dwelling, one each from before and after the retrofit, and then comparing the two whole-building energy use models to find differences in energy use profiles.

For residential energy consumers, determining the most effective strategy to reduce energy consumption can be challenging given the lack of useful data collection, formatting, and analytic techniques Installation of local power sensors on high energy draw residential devices or branch circuits can make it possible to obtain itemized energy usage by appliance thereby indicating the time-based usage and energy cost for various appliances. However, installing such devices can incur significant expense to the residential customer, sometimes in excess of the power saving that may result from action taken on the basis of the collected data.

Energy disaggregation is an analytical technique that enables the parsing of an aggregate energy signal into separate elements that can be assigned to specific energy consuming devices or groups of devices at specific times. In the case of electric data, the separate elements that make up the aggregate energy signal can include devices such as appliances, lighting, and heating, ventilating, and air conditioning (HVAC) systems. In the case of natural gas data, the separate elements that make up the aggregate energy signal can include devices such as HVAC systems, water heaters, and cooking appliances.

Various load disaggregation algorithms have been developed to deconstruct electric meter data into its constituent loads. In one example, US 2015-0012147 to Haghighat-Kashani et al. describes a method for energy monitoring including consumption for load, electricity and energy to detect which power consuming devices are turned on and off in a building and reporting usage information to a user, an automated energy management system or a utility. In another example, US 2013-0307702 to Pal et al. describes a method and system for managing energy consumption by monitoring, controlling and displaying energy usage of household appliances by way of collecting smart meter data and generating user friendly reports and graphs.

Another application designed by Bidgely™ uses software-based electricity disaggregation to extract electricity signatures unique to household appliances and track the electricity consumed by each appliance without the need for plug level hardware sensors. This technology uses a metering device which connects to an electric meter in each home being tracked to extract and disaggregate electricity data based on the electric signature of electrical appliances in the home in short time intervals.

Electrical disaggregation techniques such as the aforementioned use signal-processing techniques to analyze the components of time-series waveforms. Thus they are in point of fact not performing analysis of energy (in kWh, kJ or Btu), but rather are performing analysis of power or energy rate (in kW, Btu/second etc.). Further, such signal processing analysis is generally limited to electrical disaggregation in the residential context due to resolution requirements, and therefore excludes analysis of other forms of energy consumed, such as fuels. Appliance-level electrical disaggregation also requires sufficiently high frequency measurement so as to detect the cycling (i.e. turning on and off) of the various appliances contributing to the aggregate load. Such measurement is generally collected on the order of seconds rather than the order of hours, days, or months, and thus usually requires an extra meter device installed in the dwelling that is capable of extracting such high-frequency measurement.

In addition to a whole-building energy use model, there are common techniques available for disaggregating the total energy used over a period of time into separate components that indicate distinct usage patterns. The simplest and most common disaggregation technique involves the separation of baseload, or non-temperature dependent, usage from temperature dependent usage by subtracting a constant minimum value from all periodic values across a given time domain. With respect to monthly-billed usage, the calculation of baseload involves estimating an average monthly minimum usage and subtracting that value from each month's usage, with the remainder in each month being the temperature dependent non-baseload usage. This annual baseload estimation tends to over-estimate baseload electricity use for homes that both heat and cool with electricity as compared to what would be reasonably arrived at through a whole-building energy use model that incorporates weather data from a weather meter.

There remains a need for residential users to be able to decompose utility bill data into its constituent individual components so as to determine a simplified and economical strategy to reduce the energy usage of their homes.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for residential utility monitoring, determining sources of energy inefficiency, and improvement of energy efficiency in a dwelling.

An aspect of the present invention is to provide a system for determining at least one source of energy inefficiency of a dwelling, the system comprising: at least one energy meter for obtaining energy use data for the dwelling; at least one weather meter for obtaining weather data for the outdoor climate of the dwelling; a processor for: (i) calculating at least one energy metric for the dwelling using data obtained from the at least one energy meter and the at least one weather meter, and (ii) ranking multiple dwellings based on the at least one energy metric, wherein the ranking of the dwelling based on the at least one energy metric indicates the at least one source of energy inefficiency of the dwelling.

In an embodiment, the system comprises more than one energy meter capable of obtaining fuel consumption data and/or electricity consumption data. In another embodiment, the system further comprises at least one indoor climate monitor for obtaining indoor climate data. In another embodiment, the energy use data and/or the weather data is obtained by webscraping.

In another embodiment, the energy metric is an energy use metric. In another embodiment, the at least one energy meter obtains energy use data monthly, daily or hourly.

In another embodiment, the at least one energy metric is: energy use intensity per unit of conditioned space; temperature dependent energy use; non-temperature dependent energy use; or a combination thereof.

In another embodiment, the at least one energy metric is computed from an energy use model of the dwelling. In a preferred embodiment, the system comprises calculating a multitude of energy metrics for the dwelling, and ranking the dwelling along the multitude of energy metrics, wherein the source of energy inefficiency of the dwelling is calculated using an inverse model.

In another embodiment, the system further comprises ranking multiple dwellings using at least one physical parameter. In another embodiment, the system further comprises determining a multitude of sources of energy inefficiency.

In another embodiment, the ranking of similar dwellings using the at least one energy use metric comprises: dwellings in the same zip code, county, state, climate zone or country; dwellings of a comparable interior size or heating method; dwellings within a singular energy efficiency program or utility service area; or a combination thereof. In another embodiment, the source of energy inefficiency is a heating system, ventilation system, air conditioning system, thermal insulative quality of the structure of the dwelling, air infiltration of the structure of the dwelling, at least one energy consuming appliance within the dwelling, energy consuming behavior of occupants, or a combination thereof.

In another aspect there is provided a method for improving the energy efficiency of a dwelling, the method comprising: obtaining energy use data for the dwelling from at least one energy meter; obtaining weather data for the outdoor climate of the dwelling from at least one weather meter; calculating at least one energy metric for the dwelling using data from the at least one energy meter and the at least one weather meter; ranking the dwelling in a peer group using the at least one energy metric; and identifying at least one source of energy inefficiency from the ranking.

In an embodiment, the system further comprises obtaining indoor climate data of the dwelling from at least one indoor climate monitor. In another embodiment, the method further comprises making a recommendation to improve the energy efficiency of the dwelling. In another embodiment, the recommendation to improve the energy efficiency of the dwelling comprises: upgrading dwelling insulation; reducing air infiltration; servicing or replacing an HVAC system; servicing at least one electricity or natural gas consuming appliance; replacing at least one electricity or natural gas consuming appliance; replacing lighting with more energy efficient lighting; changing local landscaping; advising the occupants on means of improving their energy consuming behavior; or a combination thereof.

In another embodiment, the method further comprises obtaining energy data from a plurality of energy meters, wherein the plurality of energy meters are capable of obtaining fuel consumption data and/or electricity consumption data.

In another embodiment, the at least one weather meter comprises a thermometer, barometer, hygrometer, anemometer, rain gauge, snow gauge, or a combination thereof. In another embodiment, the at least one weather meter provides data to calculate heating degree days and cooling degree days for the dwelling, and wherein the calculation of heating degree days and cooling degree days is a summation of heating degree hours and cooling degree hours.

In another embodiment, the at least one weather meter is complemented by at least one indoor climate monitor within the dwelling, where the at least one indoor climate meter comprises a thermometer, barometer, hygrometer, or a combination thereof. In another embodiment, the information collected from the at least one weather meter and the at least one indoor climate meter are used to characterize the quality of the dwelling's insulation and air infiltration rates across the multiple time periods.

In another embodiment, the at least one energy metric is: energy use intensity per unit of conditioned space; temperature dependent energy use; non-temperature dependent energy use; or a combination thereof.

In another embodiment, the method further comprises calculating a multitude of energy metrics for the dwelling, and ranking the dwelling along the multitude of energy metrics, wherein the source of energy inefficiency of the dwelling is calculated using an inverse model.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 is a flowchart depicting the general application of the present system and method;

FIG. 2 illustrates one exemplary environment which can embody the present system;

FIGS. 3A and 3B illustrate the user interface with two exemplary data output screens;

FIG. 4 graphically depicts electricity consumption vs. heating degree days for a dwelling through a whole-building energy use model;

FIG. 5 is a set of four energy metric histograms for a dwelling through a whole-building energy use model as described in Example 2;

FIG. 6 is a set of two energy metric histograms for a dwelling through a whole-building energy use model as described in Example 3; and

FIG. 7 graphically depicts energy consumption vs. cooling degree days for a home having inefficient appliances as described in Example 3.

### DETAILED DESCRIPTION OF THE INVENTION

Although the detailed description contains many specifics, these should not be construed as limiting the scope of the disclosure but merely as illustrating different examples and aspects of the disclosure. It should be appreciated that the scope of the disclosure includes other embodiments not discussed in detail herein. Various other modifications, changes, and variations, which will be apparent to those skilled in the art, may be made in the arrangement, operation, and details of the methods and processes of the present disclosure disclosed herein without departing from the spirit and scope of the disclosure as described.

Unless defined otherwise, all technical terms used herein have the same meaning as commonly understood by one of ordinary skill in the art to which this invention belongs.

As used in the specification and claims, the singular forms “a”, “an” and “the” include plural references unless the context clearly dictates otherwise.

The terms “comprises” and “comprising” as used herein will be understood to mean that the list following is non-exhaustive and may or may not include any other additional suitable items, for example one or more further feature(s), component(s), metric(s), and/or element(s) as appropriate.

The terms “energy meter” and “utility meter” as used herein refer to a device capable of measuring utility usage, fuel usage and/or energy usage in a building. Non-limiting examples of energy meters are fuel meters such as oil, propane and natural gas meters, and electricity meters, including smart meters.

The terms “energy use intensity” and “energy intensity” as used herein refer to a building's energy use as a function of size or other characteristics. Units of energy intensity are typically expressed as energy consumed per unit of area or volume per unit time. A common unit for energy intensity is kBtu per square foot per year. Energy intensity can also be expressed using any other unit of area or volume per unit time. The unit of time can be, such as, for example, yearly, monthly, weekly or daily.

The term “weather meter” as used herein refers to an instrument for measuring one or more aspects of weather. Weather surrounding a building or dwelling, also referred to as the outdoor or ambient climate of the building, contributes to the energy use intensity of the building. Some non-limiting examples of weather meters include thermometers (for measuring air and sea surface temperature), barometers (for measuring atmospheric pressure), hygrometers (for measuring humidity), anemometers (for measuring wind speed), rain gauges (for measuring liquid precipitation over a set period of time) and snow gauges (to gather and measure the amount of solid precipitation). Weather meters are capable of measuring temperature, humidity, dew point, wind speed, wind direction, atmospheric pressure, solar gain, and cloud cover. Weather meters are also capable of obtaining and transmitting weather data to privately and/or publicly accessible databases. It is understood that a weather meter measures properties of the outdoor climate surrounding the building or dwelling.

The term “weather station” as used herein refers to a facility comprising instruments and equipment for measuring atmospheric conditions, and which comprises at least one weather meter.

The term “indoor climate monitor” as used herein refers to an instrument for measuring one of more aspects of the indoor climate within a building or dwelling. Some non-limiting examples of indoor climate monitors include thermometers, barometers, and hygrometers. Indoor climate monitors are capable of obtaining indoor climate data, for example temperature, humidity and atmospheric pressure. Indoor climate monitors are also capable of transmitting indoor climate data to privately and/or publicly accessible databases. It is understood that an indoor climate monitor measures properties of the indoor climate within the building or dwelling. An indoor climate metric is a metric computed using data obtained from an indoor climate monitor.

As used herein, the term “energy use analysis” refers to a set of procedures used to characterize building energy use through an analysis of prior utility bills or other energy meter data, and weather data. Energy use analysis typically takes the form of either an energy use intensity determination, or whole-building energy use modeling.

The terms “dwelling”, “residential dwelling” and “home” are used herein to describe the building or dwelling under analysis. Some non-limiting examples of dwellings include single family detached, duplex, townhouse, apartment, and condominium. A dwelling can be a stand-alone building such as a detached home, or may constitute a fraction of a building, such as in the case of an apartment, condominium, duplex or townhouse. It is understood that though the present analysis is exemplified by energy usage in residential dwellings, the same or similar system and method can also be used for utility monitoring and improving energy efficiency in non-residential buildings, such as, for example, commercial buildings, multi-tenant residential buildings, educational buildings, institutional buildings, public sector buildings, religious buildings, hospital and health service buildings, and other building types.

As used herein, the term “conditioned space” refers to the enclosed space within a building or dwelling where there is intentional control of the space thermal conditions within defined limits using natural, electrical, or mechanical means. Spaces that do not have heating or cooling systems but rely on natural or mechanical flow of thermal energy from adjacent spaces to maintain thermal conditions within defined limits are also considered conditioned spaces. The conditioned space defines the boundaries within which the indoor climate is contained. Conditioned space can be quantified in terms of area, for example in square feet, as the conditioned space area (CSA).

As used herein, the term “energy unit” refers to any unit of measurement that can be used to quantify energy usage. An energy unit can be measured, for example, in kilowatt-hours (kWh), kilojoules (kJ), British thermal units (Btu), therms, cubic feet of natural gas, or any other physical unit of any energy source, such as a fuel or electricity source.

As used herein, the term “energy metric” refers to a metric that quantifies an aspect of energy generation or use. The term “energy use metric” is an energy metric specifically pertaining to the consumption of energy.

The acronym “CV(RMSE)” refers to the Coefficient of Variation of the Root Mean Squared Error, and indicates the uncertainty in a statistical model. The acronym “R²” is the Coefficient of Determination and indicates the proportion of response variation “explained” by the regressors in a statistical model.

The term “energy consuming appliance” (ECA) refers to any device that requires energy for operation. ECAs include electrical appliances such as, for example, a refrigerator, toaster, kettle, microwave, dishwasher, stove, washing machine, dryer, water heater, electrical heater, light bulb, fan, television, electronics, chargers, etc. ECAs also include fuelled appliances that consume natural gas, propane or fuel oil, such as a conditioned space heater, water heater, stove, indoor barbecue, furnace, fireplace, etc.

The term “Heating Degree Day” (HDD) is a measurement of outdoor climate around a building that reflects the energy required to heat a building. The HDD value is an indication of how cold a location is over a period of time. One HDD is one degree colder than the heating balance point temperature of a building over the course of a 24-hour period, where the heating balance point temperature is the temperature at which the heat gains of a building are equal to the heat losses from internal heating sources. Unless otherwise available or computed, the default heating balance point temperature of a building for computation purposes is assumed to be 65° F. Where hourly temperatures are available, HDD may be computed as a summation of Heating Degree Hours. HDD can also be computed based on the maximum and minimum temperatures at a given location over the course of a given day.

The term “Cooling Degree Day” (CDD) is a measurement of outdoor climate around a building that reflects the energy required to cool a building. The CDD value is an indication of how hot a location is over a period of time. One CDD is one degree hotter than the cooling balance point temperature of a building over the course of a 24-hour period, where the cooling balance point temperature is the temperature at which the cooling gains of a building are equal to the cooling losses from internal cooling sources. Unless otherwise available or computed, the default cooling balance point temperature of a building for computation purposes is assumed to be 65° F. Where hourly temperatures are available, CDD may be computed as a summation of Cooling Degree Hours. CDD can also be computed based on the maximum and minimum temperatures at a given location over the course of a given day. Together, the terms heating degree days and cooling degree days can be referred to simply as degree days.

The term “energy use model” is a model that uses linear regression of energy use against one or more independent variables. A whole-building energy use model is an energy use model of the energy use of a whole building. One non-limiting technique of whole-building energy use modelling uses linear regression to correlate energy use as the dependent variable with weather data (such as average outdoor temperature, CDD or HDD) and/or other independent variables. Given a set of whole-building energy use models on a given dwelling, the best models are considered to be those with the lowest CV(RMSE) or highest R².

The term “webscraping” as used herein refers to a technique using a computer for extracting information from an electronic network or websites on a network. A webscraper is a routine or set of computerized commands that are capable of performing webscraping.

Described herein is a system and method for residential utility monitoring and reduction of energy consumption. The energy consumption of a building and its occupants can be characterized, and the sources of inefficient energy consumption can be identified. From the information within an energy use profile, effective strategies can be recommended for reducing dwelling energy consumption.

Also described herein is system and method for measuring weather-adjusted building energy use intensity by measuring energy consumption used for heating and/or cooling the building, measuring local weather, and calculating the energy use intensity for the building to obtain an energy use profile for a dwelling. The energy use profile for the building can then be applied to make at least one recommendation to the energy user to reduce the energy consumption of the dwelling. An energy use profile can be obtained for the dwelling based on weather data taken from at least one weather meter, and energy data taken from at least one energy meter, such as an electricity meter and/or a natural gas meter, without the need for additional meters or an on-site energy audit. Additionally, data from an indoor climate monitor can be used as input into the energy use profile.

Generally speaking, an energy audit can be used to establish the basic set of building characteristics obtained through an on-site inspection that determine its energy characteristics. Procedures for performing an energy audit of a building are known in the art, and professionals performing on-site energy audits generally examine such factors and/or elements as, for example, the dimensions and layout of rooms in the building; ceiling height; window dimensions, orientation, type, and the presence or absence of overhangs; building insulation quality, quantity, and type; overall building orientation; and internal heat loads from occupants, lighting, and equipment. If the building includes a heating or cooling system, the audit may also include an examination of the ductwork and building openings for leakage, heat loss, and insulation levels, as well as an evaluation of the heating and cooling equipment and other major appliances and their efficiency levels. The presently described system and method can derive information regarding the energy use profile of a building and/or provide one or more recommendations for reducing overall energy use without the requirement for an on-site energy audit.

With regards to energy use characterization in a dwelling, of importance to the homeowner is the knowledge of which dwelling energy system is operating at an unsatisfactory efficiency, and what can be done to improve that system's efficiency and therefore the energy efficiency of the dwelling as a whole. Main categories of dwelling energy systems include electrical appliances, fuelled appliances, cooling system, heating system, thermal envelope insulation, and thermal envelope air infiltration. Electrical appliances can be considered efficient if they provide the desired energy services with a relatively low electrical input requirement. Similarly, fuel appliances can be considered efficient if they provide the desire energy services with a relatively low fuel input requirement. Relative in this context depends on how the appliance's efficiency compares to that of other similar appliances providing similar energy services at other homes.

A cooling system can be considered efficient if it is able to remove heat (both sensible and latent) from the indoor climate within the conditioned space and dispose of it into the ambient environment around the dwelling with a relatively low electric input requirement. The cooling system efficiency is subject to various factors, including:
The Seasonal Energy Efficiency Ratio (SEER) rating of the system, in which air conditioning systems with higher SEER ratings should theoretically remove more heat per kWh of electrical input, typically in units of Btu/kWh.
The sizing of the air conditioning system relative to the volume of air in the conditioned space, where the common practice of over-sizing an air conditioning system tend to result in less efficient system performance over time.
The actual performance of the air conditioning system in terms of removal of heat (typically in units of Btu) per kWh of electrical input. The actual performance differs from the theoretical performance due to the quality of the system installation and commissioning as performed by the air conditioning contractor, the degradation of the air conditioning system due to wear and ageing, and the extent and quality of the maintenance performed on the air conditioning system over its lifetime.

The factors influencing the performance of a heating system in general and a heat pump (which is, in effect, a cooling system operating in reverse) in particular are substantially similar to those influencing the performance of a cooling system. Due to the laws of thermodynamics the efficiency of an electric heat pump is subject to the thermal gradient between the indoor climate within the conditioned space and the ambient climate around the dwelling. Therefore, the efficiency of a heat pump decreases as the ambient temperature surrounding the dwelling decreases. Other forms of heating, such as electrical resistance heating and fuelled heating (by burning natural gas, propane or fuel oil) are not subject to this effect and therefore do not degrade in efficiency with respect to a decrease in outside temperature in the manner that heat pumps do. In other respects, such as the quality of system installation and commissioning, and degradation due to wear and ageing, the factors influencing the performance of any given heating system and any given cooling system are analogous. The homeowner has a material interest in knowing whether there is an indication of inefficient heating and/or cooling system performance so that they, or an agent of the homeowner, may take appropriate action.

Thermal envelope insulation is the sum total of material in the dwelling that provides resistance to heat loss from conduction between the conditioned space and the ambient environment. Thermal envelope insulation is provided by materials encompassing both the physical structure within the walls, floor, and ceiling of the dwelling (such as, for example, fiberglass batts, spray foam, foam board, insulating concrete forms, loose-fill insulation, etc.), and the fenestration of the dwelling such as the windows and doors. The insulative quality of each component is quantified with an R-value, where R is measure of thermal resistance (whereby the inverse of thermal resistance R is thermal conduction U). The overall thermal envelope insulation is subject to the physical parameters of the dwellings and each physical parameter's individual R-value. Similarly, the overall thermal envelope insulation of the dwelling can be decomposed into the thermal resistance of subsystem envelope insulation, such as the walls, floor, ceiling windows, and doors. The overall insulative quality of a dwelling can be estimated base on the R-value of the various physical parameters, thermal imagine of the dwelling, on-site inspection of insulation installation quality, and/or other means. The homeowner has a material interest in knowing whether there is an indication of underperformance with the dwelling's thermal envelope insulation so that they, or an agent of the homeowner, may take appropriate action.

Thermal envelope air infiltration is the tendency of the thermal envelope of a dwelling to exchange air between the conditioned space and the ambient environment. Air infiltration is typically measured with a blower door test, in which a fan is installed in an exterior door of the home in order to lower the air pressure of the home. The pressure difference between the conditioned space and the ambient environment as a function of the fan speed (and therefore air flow rate through the fan) is used to quantify the number of air changes in a given period of time (represented by the coefficient K), and therefore the overall air tightness of the thermal envelope. Overall air infiltration in a dwelling is subject to both the physical characteristics of the dwelling (which are cumulatively evaluated in a blower door test), the degradation of the physical characteristics of the dwelling over time (and specifically since the most recent blower door test was performed), the frequency of fenestration penetration (i.e. window and door opening), and varying environmental conditions such as wind speed and direction. Air infiltration underperformance issues over time are usually a consequence of either air leakage through the thermal envelope, or occupant behavior as a result of a lack of discipline with regard to open windows and doors during periods of heating and cooling system operation. The homeowner has a material interest in knowing whether there are air leaks in the thermal envelope or relevant behavioral issues that result in an underperformance of the dwelling's thermal air infiltration so that they, or an agent of the homeowner, may take appropriate action. Other forms of heat transfer into and out of the dwelling, such as convection and radiation, may also be considered in the analysis of the dwelling's thermal envelope.

Through whole-building energy use modeling, energy models for dwellings can be computed. For dwellings with weather-sensitive use, three-parameter and five-parameter models are commonly used to account for weather sensitivity. Weather-dependent whole-building energy use models involve the determination of a best-fit model for energy use as a function of temperature or degree days over the period of energy use between meter reads. Weather meters can be used to obtain weather data at or near the location of the dwelling for the purposes of the present invention. Data from weather meters can be obtained directly from the a local weather meter or weather station, from data transferred from the weather meter or weather station to a computer network, or through weather meters operationally connected to a computer network. Indoor climate data can be obtained from indoor climate monitors within the dwelling where available.

Disaggregation of the energy use of a home into temperature dependent and non-temperature dependent use can provide information on the energy requirement for heating and/or cooling a home. In a heating situation, for example, the temperature dependent portion of natural gas consumption may be attributed to dwelling heating, and the non-temperature dependent portion may be attributed to natural gas consumption for appliance use. By further disaggregating the energy requirements at different times of the year and further taking into account weather measurements and/or indoor climate measurements as presently described, mathematical correlations can be made to determine the primary source(s) of energy loss caused by the structural features of a home. This determination can then provide an actionable recommendation to ameliorate the sources of energy loss, which in turn can contribute to decreasing both the electrical and fuel energy requirements for the dwelling without reducing the energy services desired by the occupants.

The present system and method provides a way to identify sources of inefficient energy use by comparing the values of at least one energy use metric on a dwelling's energy consumption to the same at least one metric for a peer group of dwellings. The energy use profile created by a combination of multiple rankings along multiple metrics indicates specific sources of energy inefficiency unique to a particular dwelling. The presently described system and method can take advantage of inverse modeling and multidimensional ranking to analyze energy usage, and is applicable to any form of energy data from any form of energy from any type of energy meter over any time period as compared to any relevant peer group.

From the perspective of mass data acquisition, at the granular level, utilities are able to extract granular information from utility bills from an individual dwelling in order to assess energy consumption and the impacts of such consumption on electricity and natural gas delivery infrastructure in terms of protection, control, cost efficiency, capacity, and power quality issues. Data acquired from a plurality of households, businesses and other energy consuming entities as to behaviors, energy consumption, and power consumption can therefore be provided in a granular form. The present system and method may also be applied for non-intrusive load monitoring, electricity monitoring, fuel energy monitoring, general energy monitoring, in-house energy management, building automation, and for other energy monitoring applications. The present system and method may also be commercialized by utilities or third parties as a product that enables energy consumers to better manage their electricity and/or fuel consumption.

Data analytics in accordance with the present system and method can also yield demand forecasts by segmenting user profiles and modeling consumption behavior separately using increased input data granularity. With access to real time segmented data, accurate short term (and long term) demand projections may be made, which can afford significant cost saving to a utility and ultimately to a consumer, whether that consumer be a family, a business, a manufacturing operation, or other entity.

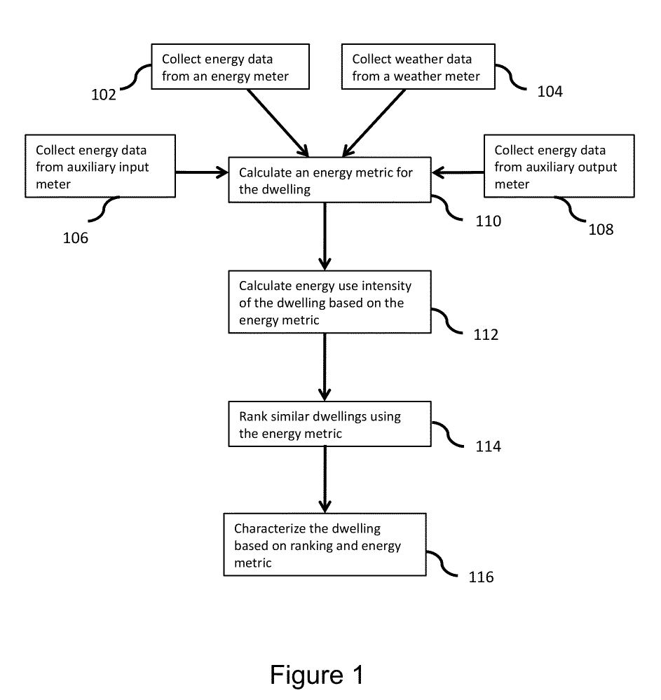

FIG. 1 is a flowchart depicting an exemplary method as described. Natural gas, fuel and/or electricity data is collected from one or more utility meters 102. Local weather data is collected from a local weather station having at least one weather meter 104. Optionally, for dwellings containing an indoor climate monitor, indoor climate data is collected using the indoor climate monitor. Optionally, for dwellings connected to one or more auxiliary power supply, auxiliary power generation data is collected using an auxiliary input meter 106, optionally using an inverter meter. Some non-limiting examples of an auxiliary power supplies are local generators, solar power generation, wind power generation, or geothermal generation. For dwellings that have an energy draw in excess of that normally found in a dwelling, such as, for example, an electric vehicle power charging station, such charging meter data can also be collected by an auxiliary output meter 108.

The data from the utility meter(s), weather meter(s), indoor climate monitor(s), auxiliary input meter(s), and auxiliary output meter(s) can be collected in multiple ways including but not limited to: manual reading of the meters with corresponding time and/or date stamps; remote reading of the meters using a device capable of recording the data from the meters with corresponding time and/or date stamps; retrieval of the data from a utility database; collecting the data from energy consumer's online accounts through the use of webscrapers; input of the data by the user; direct data feed from a database containing the relevant data, or by other means. Most electricity and retail natural gas utilities have a website on which residential customers are able to log into an online account to see their past utility bills. Accordingly, collection of utility billing information for the purposes of energy consumption analysis from utility websites can be efficiently performed through the use of webscrapers.

The data collected from the utility meter, weather meter, indoor climate monitor, auxiliary input meter, and auxiliary output meter can be used to calculate one or more energy use metrics 110 for the dwelling. From the energy use metric, the energy use intensity of the dwelling can also optionally be calculated based on the energy metric 112. Other dwellings can then be analyzed in a similar manner, and ranked along multiple usage metrics 114. Based on the individual ranking of a dwelling and on energy use metrics, a characterization of the dwelling can be ascertained 116 and preferably a recommendation can be made as to how to improve the energy efficiency of the dwelling.

Few homes are subjected to any form of detailed energy use analysis. A primary limiter is the accessibility of utility billing information. Collecting utility billing data has traditionally required the collection of paper bills or the manual reading of the utility meter. Some electric and gas utilities provide limited analysis of energy use, however such analysis is by definition limited to the information known by the utility. Electric utilities rarely know the conditioned space or square footage of the home, and unless they offer both electric and natural gas services, have no information on the natural gas consumption of their customers. Without comprehensive information on home energy consumption and ambient weather and proper computation, utilities can only provide limited analysis, and such analysis is of limited interpretive use to the occupant.

Through Executive Order, The White House has mandated targets for energy use intensity improvement for government buildings. In the future, just as cars have fuel economy standards, it is conceivable that in the future buildings, and specifically residential buildings, may also have benchmarked energy use intensity standards. A benchmark is a threshold target of a metric along a ranking beyond which the value of the metric is considered desirable.

For new homes, energy ratings are usually based, by necessity, on a physical assessment of the structure itself as-is, rather than an analysis of energy use over time with occupants present. New homes in the U.S. are evaluated based on inputs such as the insulation, the HVAC system, the windows, and the output of a blower door test. This type of evaluation is predictive in natural rather than performance-based, in so far as the evaluation is conducted irrespective of the actual energy use of the dwelling while occupied. The present system and method is a performance based rating of a dwelling based on the actual energy use over time while occupied and derived from the energy use characterization of the home described herein.

For the obtained energy usage data to be actionable, it is preferable that at least one recommendation be provided to the user that would lead to reduced overall energy use. In addition, to encourage the energy consumer to act on the at least one recommendation, it is preferable that the at least one energy saving recommendation have minimal up-front cost and/or minimal long term cost to the energy consumer. Examples of such a recommendation can include but is not limited to repair and/or upgrade of the thermal shell by adding to the dwelling insulation or by reducing air infiltration, servicing or replacing the HVAC system, servicing at least one electricity or natural gas consuming appliance, replacing at least one electricity or natural gas consuming one appliance, advising the occupants on means of improving their energy consuming behavior such as turning off lights or adjusting indoor climate, or a combination thereof. Other examples of recommendations can include but are not limited to replacing equipment with more energy efficient equipment, servicing equipment, upgrading equipment, replacing lighting with more energy efficient lighting, and changing local landscaping such as by planting trees.

The combination of online utility accounts and modern webscraping techniques unlocks the capability to collect data gleaned from physical energy meters on or in proximity to a dwelling's premise. By collecting utility data generated by on-premise energy meters directly from dwelling owners' online accounts, local weather station data from a weather station or database of weather station data, such as the National Oceanic and Atmospheric Administration (NOAA) online database, and where available indoor climate data from an indoor climate monitor, the mass computation by processors of both energy use intensity and of a whole-building energy use model can be performed for a wide variety of homes in a diverse set of locales on a perpetual basis. With the introduction of “smart meters” which have the capability of transmitting energy consumption data more frequently than monthly, such as hourly, with hourly weather data available from NOAA Class A weather stations, and with new data formats such as the Green Button xml format, enhanced data resolution enables the computation by processors of energy use metrics with more granularity than what can be computed with monthly data alone.

Energy Use Metrics

Energy use metrics are calculated in order to quantify specific aspects of a dwelling's energy use, with such quantification capable of being applied to compute characteristics of the dwelling that are of evaluative relevance. Metrics can then be used to compare aspects of a dwelling's energy use to those of similar dwellings in order to obtain information on the performance of the dwelling along multiple dimensions as compared to a given peer group, where peer groups may include but are not limited to dwellings of a similar size, location (which may include neighborhood, municipality, zip code, county, state, or other), age, climate zone, construction materials, occupant demographics, occupant behavior, heating method, common energy efficiency program, utility service area, or any combination of the aforementioned criteria or other possible peer groups. Characterization of the energy use of a dwelling is performed in part on the basis of the ranking of the dwelling as compared to a given peer group along multiple energy metric ranking histograms, with the rankings varying by the criteria defining the comparison sets. The ultimate purpose of peer group comparison in the context of any given energy use metric is to establish whether a given dwelling's performance along the dimension of that metric could be consider preferable, normal, or undesirable as compared to the performance of other dwellings in the same peer group along the same dimension.

Where a metric identifies either the evidence of inefficiency or the source of inefficiency, such identification is actionable by the homeowner or by an agent on behalf of the homeowner with an interest in improving the energy efficiency of at least one aspect of the dwelling. To the homeowner, the energy efficiency of all energy consuming systems within the dwelling and of the dwelling itself are significant due to the money saving potential and asset valuation increase as a result of appropriate home energy system improvements. Information that can illuminate for a homeowner a specific source of inefficiency, especially when coupled with the financial cost of said inefficiency, can be highly influential to homeowner behavior.

Each energy use metric can be, for example, an electricity use metric, a fuel use metric, or a combination thereof. Non-limiting examples of electricity use metrics include:
kWh per time interval
kWh per conditioned space area per time interval
kWh per conditioned space area per CDD per time interval
kWh per conditioned space area per HDD per time interval
Baseload use in kWh per time interval
Baseload use in kWh per conditioned space area per time interval
Total use above baseload use in kWh per time interval
Total use above baseload use in kWh per conditioned space area per time interval
Total four-month use during summer months in kWh
Total four-month use during summer months in kWh per conditioned space area
Total four-month use during winter months in kWh
Total four-month use during winter months in kWh per conditioned space area

Non-limiting examples of fuel use metrics include:
Therms or cubic feet of natural gas per time interval
Therms or cubic feet of natural gas per conditioned space area per time interval
Therms or cubic feet of natural gas per conditioned space area per HDD per time interval
Baseload use in therms or cubic feet of natural gas per time interval
Baseload use in therms or cubic feet of natural gas per conditioned space area per time interval
Total use above baseload use in therms or cubic feet of natural gas per time interval
Total use above baseload use in therms or cubic feet of natural gas per conditioned space area per time interval
Total four-month use during winter months in therms or cubic feet of natural gas
Total four-month use during winter months in therms or cubic feet of natural gas per conditioned space area

Metrics which totalize energy consumption across multiple energy sources are useful in peer group comparison of similar dwellings with different energy source usages, such as the comparison of a dwelling with electricity service only to a second dwelling with both electricity and natural gas service and a third dwelling with electricity service and delivered fuel oil. Also, comparing similar such dwellings during winter heating periods requires accounting for the heat produced within the dwellings not only by heating elements for the purpose of conditioned space heating, but also the bi-product waste heat generated by electrical and fuelled appliances. Non-limiting examples of energy use metrics which are applicable to individual, combination, or total input use include:
Btu or kJ per time interval
Btu or kJ per conditioned space area per time interval
Btu or kJ per conditioned space area per CDD per time interval
Btu or kJ per conditioned space area per HDD per time interval
Baseload use in Btu or kJ per time interval
Baseload use in Btu or kJ per conditioned space area per time interval
Total use above baseload use in Btu or kJ for a time interval over a given time period
Total four-month use during summer months in Btu or kJ
Total four-month use during summer months in Btu or kJ per conditioned space area
Total four-month use during winter months in Btu or kJ
Total four-month use during winter months in Btu or kJ per conditioned space area

In addition to appliances with the intended purpose of either providing conditioned space heating and cooling or delivering desired energy services within the dwelling, the energy use profile of a dwelling can be affected by additional extraneous energy sources and consuming use unique to a particular dwelling. For example, a given dwelling may have rooftop solar panels, an electric vehicle, a back-up power generator, a combined heat and power system, and/or other such unique energy consuming or producing features. Other such non-limiting examples of additional metrics applicable to energy usage analysis may therefore also include:
kWh of electric vehicle battery storage charging or discharging per time interval
Btu of thermal storage charging or discharging per time interval
Solar panel kWh production per time interval
Power generator fuel consumption and kWh production per time interval

In addition to energy use metrics generated from metered energy consumption data, indoor climate metrics can be generated using computed outputs of indoor climate monitors. Non-limiting examples of indoor climate metrics include:
Rate of energy transfer, or heat flux, through the thermal envelope during any given time period, in W/m² or similar unit
Heat transfer coefficient of the thermal envelope during any given time period, in W/(m²*° C.) or similar unit
Time constant (i.e. tau) of thermal loss from the indoor climate to the ambient environment in any given time period
Computed rate of air infiltration at any given time in units of cubic feet per minute at a given pressure gradient or similar unit
Computed stack effect draft flow rate at any given time in units of cubic feet per minute or similar unit

In addition to metrics generated directly from metered energy consumption data or indoor climate data, additional metrics can be generated through computed outputs of a whole-building energy use model. A non-limiting sample of whole-building energy use model metrics includes:
Temperature dependent energy use for heating in energy units per degree or HDD per time interval
Non-temperature dependent energy use in energy units per time interval
Temperature dependent energy use for cooling in energy units per degree or CDD per time interval
Ratio of electric use for heating vs. cooling over a given time interval
Ratio of electric use for heating or electric use for cooling in kWh per total electric use in kWh over a given time interval
Cooling balance point temperature in ° F. or ° C.
Heating balance point temperature in ° F. or ° C.
R² value of the whole-building energy use model, where R² is the coefficient of determination of the computer-determined whole-building energy use model
CV(RSME) value of the whole-building energy use model, where CV(RSME) is the coefficient of variance of the root-mean-square error of the computer-determined whole-building energy use model
Any derivative metric generated by comparing the actual value of an energy use metric over a given time period to the modelled value of the same energy use metric generated by the whole-building energy use model over the same time period.

As the number of energy use metrics used to evaluate the dwelling, the size and granularity of peer groups from which rankings are derived, and the resolution of time intervals (from months to days, hours and minutes) increase, the precision of the energy use profile interpretations also increases. As a result, with sufficient metrics, rankings, time intervals, and peer groups, precise characterizations of energy consumption for each individual dwelling can be constructed. The characterization of energy consumption for the individual dwelling is referred to herein as the energy use profile.

Energy Consumption Inverse Modeling Through Multidimensional Ranking

Energy use analysis is an analysis of the complex dynamics of the physical structure and infrastructure present in a dwelling, the appliances present, the physical location and associated climate, the number and demographics of the occupants, and the lifestyle and behavior of the occupants. Some non-limiting examples of variables which contribute to energy use include the dwelling type (single-family detached, duplex, townhouse, mobile home, etc.), number of occupants, year of construction, age of heating and cooling equipment, regularity of heating and cooling equipment maintenance, income level of occupants, age of occupants, conditioned space area, conditioned space volume, climate region, occupant behavior, percent of time occupied, intensity of energy appliance energy use while occupied, discipline regarding sources of air leakage (such as open doors and windows), types and quantity of appliances, outside wall construction, type and quality of insulation, fenestration, shading, orientation, roofing material, and a host of other variables. The sharing of walls, roofs, plumbing, as well as appliances such as water heaters, interior climate control systems such as HVAC and humidification systems with one or more dwellings also contribute to the energy use analysis profile of an individual dwelling. Accordingly, every home is different and will have a different energy use profile. Further, every occupant uses energy in his or her home differently, which further complicates the analysis of a dwelling's energy use.

To customize energy use profiles and therefore provide an accurate energy use profile and energy savings recommendations for each individual dwelling, the present system and method comprises performing a multidimensional ranking of a set of energy metrics pertaining to the dwelling against the same set of energy metrics for a set of similar dwellings, and preferably the use of an inverse model to infer the unique characteristics of the dwelling that dictate energy use characteristics.

Multidimensional ranking is a technique for comparing many entities of a similar type to one another across a multitude of metrics, whereby each entity can be characterized by quantified values of each of the metrics. The entities can then be compared to and ranked against one another by the metrics, and collectively the set of comparisons and rankings across all of the metrics can provide a unique characterization of each individual entity.

Inverse modeling is a technique for converting a set of observed measurements into information about a physical system. Inverse models are used to induce properties of a physical system that cannot be directly observed. The characterization of each individual dwelling established based on the multidimensional ranking of each dwelling, the energy use metrics of each dwelling, and the whole-building energy use model metrics for each dwelling constitute a set of observed measurements about each dwelling, which through inverse modeling forms a custom characterization or energy use profile of the nature of energy consumption in each individual dwelling and therefore a set of parameters that describe the nature of energy consumption in a given dwelling.

The following provides an illustrative example of how to estimate six values of primary importance to ensure a high-performing home: Heating System Efficiency; Cooling System Efficiency; Electrical Appliance Efficiency; Fuel Appliance Efficiency; Insulation; and Air Infiltration.

Total Energy Consumption in a Dwelling

For illustrative purposes, considered here is a simplified mathematical model for the most common energy consumption single family detached residential dwelling profile, which is a dwelling that consumes electricity and a fuel (mostly likely natural gas), and generates no electrical energy of its own. In any given time period, the energy consumption of such a dwelling can be characterized as:

E_{Tt}=E^{e}_{Tt}+E^{f}_{Tt}

where:
E_{Tt}=The total energy use of the dwelling in time period t;
E^{e}_{Tt}=The total electrical energy use of the dwelling in time period t; and
E^{f}_{Tt}=The total fuel energy use of the dwelling in time period t, where the fuel is most likely natural gas, but may also be propane, fuel oil, or another fuel.

For simplicity, consider that the following equations can be evaluated for a range of given time periods t, and so neglect t from all terms, hence:

E_{T}=E^{e}_{T}+E^{f}_{T}

In the unique case of electric-only homes, this simplifies to:

E_{T}=E^{e}_{T}

Energy services can be defined as the desired services provided by appliances that are powered by electricity. Examples of energy services include lumens of light, entertainment provided by televisions and stereos, and cooking services provided by kitchen appliances. Note that LED light bulbs are more efficient than incandescent light bulbs for the reason that they are able to provide the same energy services (in lumens) for less electrical consumption because they produce less waste heat.

Electrical appliances all emit heat, but can be divided into those whose purpose is to heat the conditioned space as electric heaters, such as heat pumps and strip heaters, and those that emit heat in the course of providing useful energy services, such as light bulbs, electronics, hair dryers, and others. For those that have a primary purpose other than to heat the conditioned space, the energy consumption of the appliance can be considered to be:

E^{e}ₙ=E^{e}_{nS}+Q^{e}_{nS}

where:
E^{e}ₙ=Electrical consumption of appliance n;
E^{e}_{nS}=Energy consumed by electrical appliance n to deliver energy services (excluding waste heat); and
Q^{e}_{nS}=Heat generated within the conditioned space as waste heat by electrical appliance n.
   Note that any heat Q can include both sensible and latent heat in any context.

Total electricity use in a dwelling in a given time period can be decomposed to:

E^{e}_{T}=E^{e}_{TS}+Q^{e}_{TS}+Q^{e}_{H}−Q^{e}_{AC}

where:
E^{e}_{TS}=Total energy consumed by all electrical appliances to deliver energy services (excluding waste heat);
Q^{e}_{TS}=Total heat generated within the conditioned space as waste heat by all electrical appliances;
Q^{e}_{H}=Heat generated within the conditioned space by electric heaters; and
Q^{e}_{AC}=Heat generated within the conditioned space by electric air conditioners (note that this term is negative as heat is removed from the conditioned space to proving cooling).

Similarly, total fuel use in a dwelling in a given time period can be decomposed to:

E^{f}_{T}=E^{f}_{TS}+Q^{f}_{TS}+Q^{f}_{H}

where:
E^{f}_{TS}=Total energy consumed by all fueled appliances to deliver energy services (excluding waste heat);
Q^{f}_{TS}=Total heat generated within the conditioned space as waste heat by all fueled appliances; and
Q^{f}_{H}=Heat generated within the conditioned space by fueled furnaces for the purposes of heating the conditioned space.

The total energy consumption of a dwelling in time period t can thus be represented as:

E_{T}=E^{e}_{T}+E^{f}_{T}=E^{e}_{TS}+E^{f}_{TS}+Q^{e}_{TS}+Q^{e}_{H}−Q^{e}_{AC}+Q^{f}_{TS}+Q^{f}_{H}

where E^{e}_{TS} and E^{f}_{TS} (and by extension Q^{e}_{TS} and Q^{f}_{TS}) can be further decomposed to:

E^{e}_{TS}=Σⁿ_{c=1}E^{e}_{nS} and E^{f}_{TS}=Σⁿ_{c=1}E^{f}_{nS}

where all electric and fueled appliances n are accounted for in the model. The model can be abstracted to any desired complexity by selecting the desired number of appliances n to be considered for computation.

The sum total of heat sources in a dwelling can thus be considered as:

Q^{e}_{TS}+Q^{e}_{H}−Q^{e}_{AC}+Q^{f}_{TS}+Q^{f}_{H}

Thermal Balance in a Dwelling

The thermal balance of dwelling is a product of the internal heat (and cool) generation within the conditioned space, and of the properties of the thermal envelope. For illustrative purposes, heat loss via conduction through the thermal envelope and via air infiltration will be considered, though a complete thermal balance model can include heat flow into and out of a home as a result of convection and radiation.

The heat loss from conduction over a given time period can be represented as:

Q_{U}=U_{T}*A*ΔT

where:
Q_{U}=Heat loss through the thermal envelope due to conduction;
U_{T}=Total thermal conduction of the thermal envelope (note that U=1/R where R is the thermal resistance of the thermal envelope);
A=Surface area of the thermal envelope (note that the surface area of a dwelling's thermal envelope can be approximated if the conditioned space area is known); and
ΔT=Difference in temperature between the conditioned space and the outdoor climate (note that the temperature difference can be approximated by considering the temperature obtained from a weather meter over the course of the given time period; and the heating and/or cooling balance point temperatures calculated from the whole building energy model, absence internal temperature data from a thermometer or thermostat).

The heat loss from air infiltration over a given time period can be represented as:

Q_{I}=0.018*V*K_{T}*ΔT

where:
Q_{I}=Heat loss through the thermal envelope due to air infiltration;
0.018=Heat capacity of air in units of Btu/(cubic foot*° F.);
V=Volume of the air in the dwelling in the conditioned space (note that the volume of air in a dwelling can be approximated if the conditioned space area is known);
K_{T}=Number of air changes in a given time period due to all sources of air infiltration; and
ΔT=Difference in temperature between the conditioned space and the outside environment.

Key to the evaluation of a dwelling's energy performance are the calculation of U (i.e. thermal conduction) and K (i.e. air change rate). The most common actions taken to improve the performance of a dwelling's thermal shell involve lowering U and/or K. The purpose of the inverse model explained herein includes the estimation of parameters U and K for any particular dwelling and thereby recommendations for the homeowner regarding the appropriate course of action if U and/or K are found to be unsatisfactory. Note that U and K can be further decomposed to:

U_{T}=Σⁿ_{c=1}Uₙ and K_{T}=Σⁿ_{c=1}Kₙ

where all sources of conductivity n (including through various walls, windows, doors, floor, and ceiling) and all sources of air infiltration n (including through various light fixtures, gaps in the thermal shell, cracked windows, and opened windows and doors) are accounted for in the model. The model can be abstracted to any desired complexity by selecting the desired number of sources of conductivity Uₙ and air infiltration Kₙ to be considered for computation.

The sum total of heat losses in a dwelling can thus be considered as:

Q_{R}+Q_{I}=U_{T}*A*ΔT+0.018*V*K_{T}*ΔT

The thermal balance of a dwelling can then also be computed by setting the heat sources equal to the heat losses:

Q^{e}_{TS}+Q^{e}_{H}−Q^{e}_{AC}+Q^{f}_{TS}+Q^{f}_{H}=U_{T}*A*ΔT+0.018*V*K_{T}*ΔT

Therefore the critical thermal envelope output parameters U_{T} and K_{T} can be arrived at through estimation of the value of the heat sources across multiple time periods.

The governing equation for total energy consumption of a dwelling taking into account the combination of all appliance energy services and all sources of thermal energy loss can be summarized as:

E_{T}=Σⁿ_{c=1}E^{e}_{nS}+Σⁿ_{c=1}E^{f}_{nS}+A*ΔT*Σⁿ_{c=1}Uₙ+0.018*V*ΔT*Σⁿ_{c=1}Kₙ

Inverse Model of Dwelling Energy Characterization

An inverse model can be generalized in the form:

dₙ=Gₙₘ(mₘ)

where:
dₙ=a vector of dimensions (n×1) denoting the parameters based on observed data, referred to as the parameter vector;
Gₙₘ=a matrix of dimensions (n×m), referred to as the observation matrix; and
mₘ=a vector of dimensions (m×1) denoting the best model, referred to as the model vector.

In the case of dwelling energy characterization, the objective is to find the best model mₘ available. For illustrative purposes, the vector m₇ representing E_{T} could be represented as:

m₇=(E^{e}_{Ts},E^{f}_{TS},Q^{e}_{TS},Q^{e}_{H},Q^{e}_{AC},Q^{f}_{TS},Q^{f}_{H})

The vector dₙ is represented by a set of n metrics pertaining to the energy consumption in the dwelling. For illustrative purposes, the vector d₁₂ described herein comprising a set of metrics derived from observed data over a given period of time about the energy consumption of the home could be represented as:

d₁₂=(CSA,E^{e}_{T}/CSA,E^{e}_{B}/CSA,E^{e}_{A}/CSA,E^{e}_{H}/CSA,E^{e}_{AC}/CSA,E^{f}_{T}/CSA,E^{f}_{B}/CSA,E^{f}_{A}/CSA,E^{f}_{H}/CSA,T^{BP}_{C},T^{BP}_{H})

where:
CSA=The conditioned space area of the dwelling, typically in units of square feet;
E^{e}_{T}/CSA=The total electrical energy consumption per CSA;
E^{e}_{B}/CSA=The computed baseload electrical energy consumption per CSA;
E^{e}_{A}/CSA=The electrical energy consumption above computed baseload per CSA;
E^{e}_{H}/CSA=The electrical energy consumption for space heating per CSA;
E^{e}_{AC}/CSA=The electrical energy consumption for space cooling per CSA;
E^{f}_{T}/CSA=The total fuel energy consumption per CSA;
E^{f}_{B}/CSA=The computed baseload fuel energy consumption per CSA;
E^{f}_{A}/CSA=The fuel energy consumption above computed baseload per CSA;
E^{f}_{H}/CSA=The fuel energy consumption for space heating per CSA;
T^{BP}_{C}=The computed balance point temperature for space cooling of the dwelling (alternatively, the average indoor temperature during cooling periods); and
T^{BP}_{H}=The computed balance point temperature for space heating of the dwelling (alternatively, the average indoor temperature during heating periods).
   Additional metrics as outlined herein, such as model outputs from the whole-building energy use model, can also be used as values in the parameter vector.

For illustrative purposes, given the parameter vector d₁₂ and the model vector m₇, the inverse model can be represented as:

d₁₂=G_{(12,7)}(m₇)

where G_{(12,7)} is the observation matrix comprising 12×7 coefficients G_{(i,j)} such that:

G_{(i,j)}=F_{(i,j)}[M^{R}ᵢ]

where:
M^{R}ᵢ=The rank of metric dⱼ relative to a given peer group p of similar homes over a given time period t; and
F_{(i,j)}=A function relating the metric rank M^{R}ᵢ of metric dᵢ and other relevant inputs to the best model parameter mⱼ.

Dwelling System Energy Efficiency

Energy efficiency in a general context is defined as the energy services output of a system divided by the energy input into the system. In the context of the illustrative example above, the follow are examples of dwelling system energy efficiency:
Heating System Energy Efficiency=(Q^{e}_{H}+Q^{f}_{H})/(E^{e}_{H}+E^{f}_{H})
Cooling System Energy Efficiency=Q^{e}_{AC}/E^{e}_{AC}
Electrical Appliance Energy Efficiency=E^{e}_{TS}/(E^{e}_{T}−E^{e}_{AC}−E^{e}_{H})
Fuel Appliance Energy Efficiency=E^{f}_{TS}/(E^{f}_{T}−E^{f}_{H})
   Note that each of these energy efficiencies can be computed directly from elements of the model vector described in the illustrative example above.

As every homeowner directly benefits from improvements in the efficiency of energy consuming systems within their dwelling, and the model vector parameters are required to be known in order to quantify and therefore assess multiple dwelling system energy efficiencies, the means of determining the best model vector parameters described herein is of significant interest.

Solving the Inverse Model of Dwelling Energy Characterization

The general solution to a linear inverse model, known as the Normal Equation, is:

m=(G^{T}G)⁻¹G^{T}d

where G^{T} is the matrix transpose of G.

Using the above illustrative example, solving for m₇ given d₁₂ and G_{(12,7)} would thus yield:

m₇=G_{(12,7)}^{T}G_{(12,7)})⁻¹G_{(12,7)}^{T}d₁₂

This computation of mₘ involves a linear regression analysis in which the discrepancy between the energy use metrics dₙ and the observation matrix Gₘₙ as applied to the model mₘ is minimized though the computation of ordinary least squares (OLS) to determine the best fit model mₘ. Note that minimizing OLS to solve for the best fit model vector mₘ is analogous in methodology to minimizing CV(RMSE) to solve for the whole-building energy use model.

Computation of mₘ can be completed with any arbitrary number of model parameters. A generalized equation of model parameters mₘ that comprise E_{T} is:

E_{T}=Σⁿ_{c=1}E^{e}_{nS}+Σⁿ_{c=1}E^{f}_{nS}+A*ΔT*Σⁿ_{c=1}Uₙ+0.018*V*ΔT*Σⁿ_{c=1}Kₙ

This generalized equation can be applied with any number of parameters dₙ such that the more parameters used, the more precise the characterization of the components of energy in a given dwelling. Computing vector mₘ with large numbers of model parameters would require a high time resolution of energy use measurements from which to compute metrics, as well as a diversity of peer groups from which to calculate metric rank, and physical parameters of the dwelling beyond the most basic of parameters such as conditioned space area and location. However, even at the relatively few number of 7 model parameters, meaningful information can be derived that indicates the nature of inefficient energy use or excessive thermal losses in a given dwelling.

The inclusion of physical parameters of the dwelling beyond, for example, conditioned space area and location, can be used in the model vector to further refine the inverse model precision and scope. Physical parameters that could be included in the model may include:
The HVAC system or systems operating condition based on age, model, SEER rating, energy output, energy input, air speed, or another aspect of the HVAC system or systems;
The air infiltration of the dwelling as measured by a blower door test or computed with indoor climate data;
The insulative quality of the dwelling based on the physical properties of the dwelling's insulative components, thermal imaging of the heat loss from any part of the dwelling, computed with indoor climate data, or other means.

In the absence of a solution to the inverse model, model vector parameters can also be estimated through the use of proxies based on values of the parameter vector and other measurable observations about the energy consumption of the dwelling, as well as estimates and approximations of various values pertaining to the energy consumption of the dwelling. Should only a limited number of model vector parameters be sought, and sufficient observations, estimates, and reasonable approximations are available to characterize energy consumption, a direct computative approach to solving for discrete vector model parameters may be acceptable.

Implementation

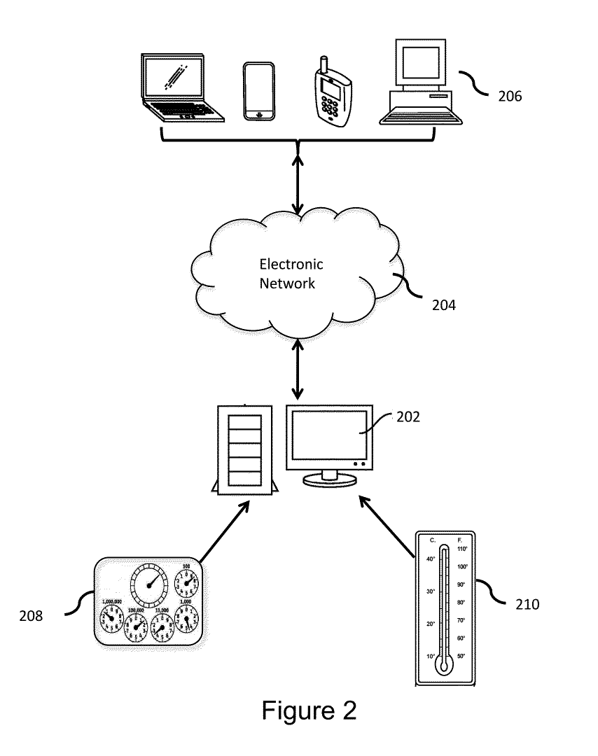

FIG. 2 shows computer system components on which the methodologies of the present disclosure may be carried out. A processor 202 is operable to run the methods of the present disclosure. As described, data is gleaned from one or more weather meter 210 and one or more energy meter 208. In addition, one or more indoor climate monitor can also be used to obtain indoor climate data. In one embodiment, a memory device may store a module and the models of the present disclosure for calculating the energy use profile of a dwelling as described above. The module and/or computer instructions for calculating the energy use profile of a dwelling, for example, as described herein, may be also stored in a permanent storage device, cloud storage device, and/or received from or communicated across an electronic network 204.

The processor 202 may be also operable to execute a user interface on the end-use device 206, for instance, for communicating with the user, receiving data from the user and presenting output to the user. The electronic network 204 is configured to connect the end-use device 206 and the profile generator. The end-use device 206 may be connected to the profile generator by utilizing the electronic network 204 with or without a wireless network. It is further contemplated that the end-use device 206 may be connected directly to the profile generator without utilizing a separate network, for example, through a USB port, Bluetooth, infrared (IR), firewire port, thunderbolt port, ad-hoc wireless connection, cellular data network and the like.

The end-use device 206 may be a desktop computer, laptop computer, tablet computer, personal digital assistant (PDA), smartphone, mobile phone, and the like. Generally, the end-use device 206 may comprise a processing unit, memory unit, one or more network interfaces, video interface, audio interface, and/or one or more input devices such as a keyboard, a keypad, or a touch screen. Optionally, the end-use devices 206 may comprise one or more global position system (GPS) transceivers that can determine the location of the end-use device 206 based on the latitude and longitude values. Additionally and optionally, position data may be obtained through cell tower triangulation, Wi-Fi positioning, or any other methods or technologies for obtaining the position of the end-use device 206.

The network interface of the end-use device 206 may directly or indirectly communicate with the electronic network 204 such as through a base station, a router, switch, modem, or other computing device. In one embodiment, the network interface of the end-use device 206 may be configured to utilize various communication protocols such as GSM, GPRS, EDGE, CDMA, WCDMA, Bluetooth, ZigBee, HSPA, LTE, and WiMAX. The network interface of the end-use device 206 may be further configured to utilize user datagram protocol (UDP), transport control protocol (TCP), Wi-Fi, satellite links, cellular data links, and various other communication protocols, technologies, or methods. The network interface of the end-use device 206 may be configured to utilize analog telephone lines (dial-up connection), digital lines (T1, T2, T3, T4 and the like), Digital Subscriber lines (DSL) or the like.

In one embodiment, the end-use device 206 is a web-enabled device comprising a browser application such as Microsoft Internet Explorer, Google Chrome, Mozilla Firefox, Apple Safari, Opera, or any other browser or mobile browser application that is capable of receiving and sending data, and/or messages through the electronic network 204. The browser application may be configured to receive the display data of the user interface, such as graphics, text, multimedia using various web-based languages such as hyperText Markup Language (HTML), Handheld Device Markup Language (HDML), eXtendable markup language (XML), and the like. The end-use device 206 may also include a web-enabled application that allows a user to access a system managed by another computing device, such as the profile generator or user interface. In one embodiment, the application operating on the end-use device 206 may be configured to enable a user to create, manage, and/or log into a user account residing on the profile generator. The profile generator is further configured to generate a utility consumption profile for the dwelling based on the disaggregated historical utility consumption data. The generated energy use profile may then be transmitted to the end-use device 206, whereby it is presented to the user. In general, the end-use device 206 may utilize various client applications such as browser applications, dedicated applications, or web widgets to send, receive, and access content such as energy use profile, consumption data and energy saving data residing on the profile generator via the electronic network 204, and/or the electronic network 204.

The profile generator may comprise one or more network computing devices that are configured to provide various resources and services over a network. For example, the profile generator may provide FTP services, APIs, web services, database services, processing services, or the like. In general, the profile generator comprises a processing unit, memory unit, video interface, memory unit, network interface, and bus that connect the various units and interfaces. The network interface enables the profile generator to connect to the Internet or other network. The network interface is adapted to utilize various protocols and methods including but not limited to UDP, and TCP/IP protocols. The memory unit of the profile generator may comprise random access memory (RAM), read only memory (ROM), electronic erasable programmable read-only memory (EEPROM), and basic input/output system (BIOS). The memory unit may further comprise other storage units such as non-volatile storage including magnetic disk drives, flash memory and the like. The memory unit of the profile generator may include a data manager that is configured to store and manage data such as webpage, personal information, dwelling particulars such as area and location, energy consumption data, weather data, etc. The profile generator may further comprise an account manager that is configured to manage and control user access of the data stored by the data manager through various authorization and authentication methods.

The profile generator can further comprise an operating system and other applications such as database programs, hyper text transport protocol (HTTP) programs, user-interface programs, IPSec. programs, VPN programs, account management programs, and web service programs, and the like. The profile generator may be configured to provide various web services that transmit or deliver content over a network to the end-use device 206. Exemplary web services include web server, database server, massager server, content server, etc. Content may be delivered to the end-use device 206 as HTML, HDML, XML, or the like.

In one embodiment, the profile generator is configured to receive historical utility consumption data and weather data for a dwelling over a time period. Preferably, the historical utility consumption data and/or weather data is obtained from webscraping. The user interface can also be configured to prompt the user to upload the historical energy consumption data to the profile generator. The upload may comprise uploading a historical energy consumption document file of various formats such as PDF, Microsoft Word, Microsoft Excel, Microsoft PowerPoint and the like to the profile generator. The upload may further comprise scanning and uploading an image of the historical energy consumption document using a scanner, and capture and upload an image of the historical energy consumption document using a camera. Alternatively, the user may manually input the historical energy consumption data through the user-interface. As another alternative, energy use data for the dwelling can be accessed via third party databases or websites such as utilities, energy companies and/or governmental or non-governmental organizations. The profile generator may further comprise a data extractor that is configured to extract data from the obtained historical energy consumption data. In another embodiment, the user interface may prompt the user to enter information such as the address of the dwelling and the profile generator can be configured to automatically obtain the historical utility consumption data from the data manager of the profile generator or one or more external databases. The profile generator may also be configured to receive location data from the GPS transceiver of the end-use device 206, and the profile generator may obtain the historical utility consumption data based on the location data. The user-interface may also prompt the user to enter other user-related data such as age, education level, number of residents in the dwelling, energy consuming appliance use or features, behavioral characteristics of the residents having regard to energy use, and/or environmental awareness.

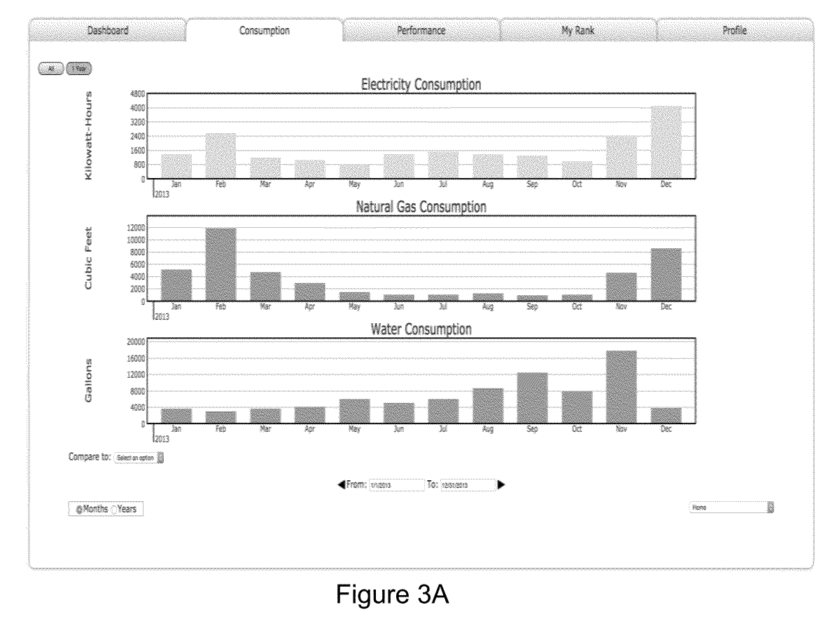

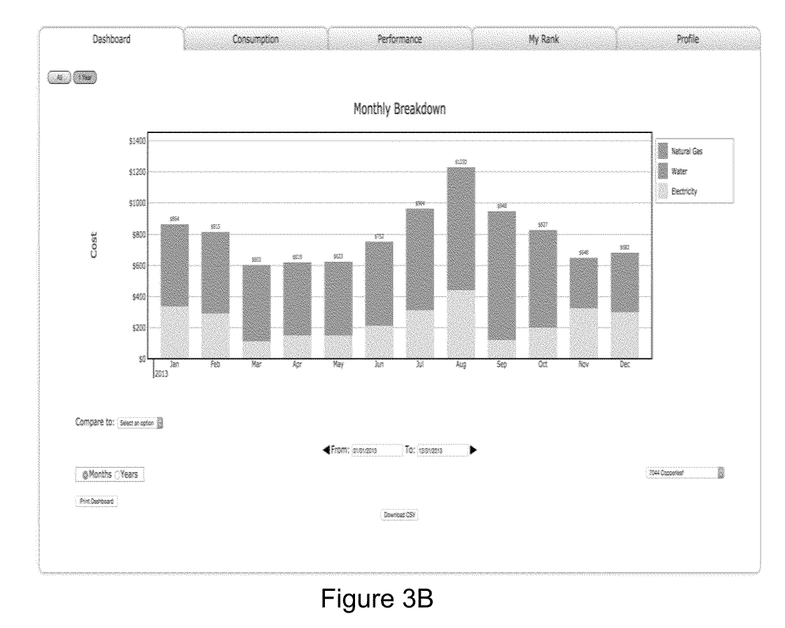

The profile generator may further provide one or more user-interfaces that allows the collection of data indicating one or more parameters of the dwelling. In one embodiment, the profile generator is configured to provide a user interface such as a webpage or application that is presented to a user through the end-use device 206. Alternatively, the user-interface may be presented to the user through a dedicated application, a web widget, or the like. FIGS. 3A and 3B are exemplary screen shots of a user interface that present building energy use data. Via the user interface, a user may be able to select a building or dwelling and view the energy use profile associated with the building. The user interface can then present the energy usage information and/or the energy use profile of the dwelling to the user. The user interface can also be configured to make concrete recommendations to the user for decreasing energy use in the dwelling.

The systems and methodologies of the present disclosure may be carried out or executed in a computer system that includes a processing unit, which houses one or more processors and/or cores, memory and other systems components (not shown expressly in the figures) that implement a computer processing system, or computer that may execute a computer program product. The computer program product may comprise media, for example a hard disk, a compact storage medium such as a compact disc, flash drive, or other storage device, which may be read by the processing unit by any techniques known or will be known to the skilled person for providing the computer program product to the processing system for execution. The computer system may be connected or coupled to one or more other processing systems such as a server, other remote computer processing system, network storage devices, via any one or more of a local Ethernet, WAN connection, Internet, etc. or via any other networking methodologies that connect different computing systems and allow them to communicate with one another. The presently described system and method may be implemented in a computer network as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components.

The computer program product may comprise all the respective features enabling the implementation of the methodology described herein, and which, when loaded in a computer system, is able to carry out the present method. Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages. The program code may execute entirely on the end-use device, partly on the end-use device, as a standalone software package, partly on the end-use device and partly on a remote computer or entirely on the remote computer or server. In the latter scenario, the remote computer may be connected to the end-use device through any type of electronic network, including a local area network (LAN) or a wide area network (WAN), or the connection may be made to an external computer, for example, through the Internet using an Internet Service Provider.

To gain a better understanding of the invention described herein, the following examples are set forth. It should be understood that these examples are for illustrative purposes only. Therefore, they should not limit the scope of this invention in any way.

### EXAMPLES

### Example 1

### Sample Energy Calculation

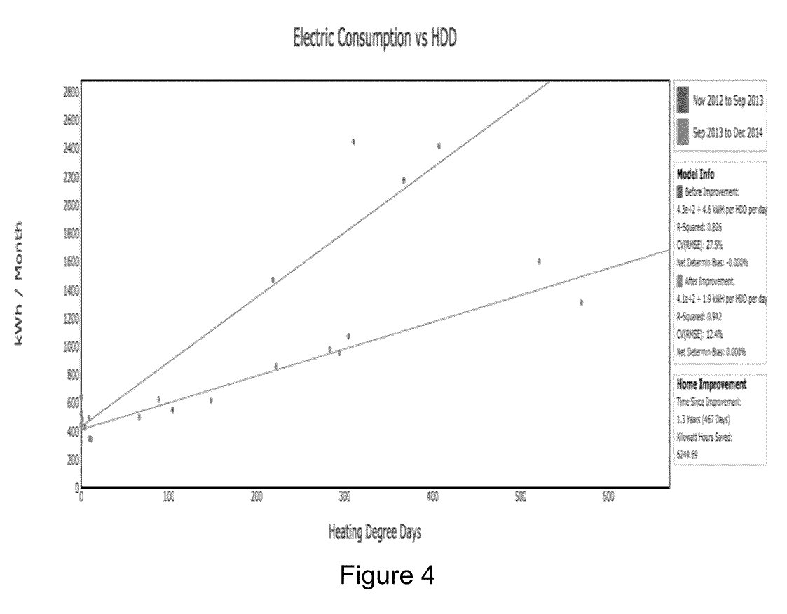

Dwelling unit energy characterization using the proposed system and method involves the interpretation of at least one energy metric and its associated ranking. Characteristics of the residential dwelling which contribute to the energy efficiency or inefficiency of the dwelling include: condition of the heating, ventilation, and air conditioning systems; the thermal insulative quality of the structure; the air infiltration of the structure; the efficiency of energy consuming appliances within the residential dwelling; and the energy consuming behavior of the occupants. A calculation of multiple energy metrics for a dwelling through a whole-building energy use model expressed as electricity consumption vs. heating degree days is shown in FIG. 4. The energy metrics depicted include the following:
Non-temperature dependent energy use in energy units per time interval, both before and after a home energy efficiency improvement.
Temperature dependent energy use in energy units per time interval per heating degree day (or per degree), both before and after a home energy efficiency improvement.
R² value of the whole-building energy use model, where R² is the coefficient of determination of the model, both before and after a home energy efficiency improvement.
CV(RSME) value of the whole-building energy use model, where CV(RSME) is the coefficient of variance of the root-mean-square error of the whole-building energy use model, both before and after a home energy efficiency improvement.

The whole-building energy use model metrics depicted in FIG. 4 serve as inputs to the energy use characterization of the home, including as variables in the calculation of heating system energy efficiency, electrical appliance energy efficiency, and thermal envelope performance, and also serve as metrics in the parameter vector for use in the inverse model. These metrics can be used to evaluate the home against similar homes, and, with the addition of the amount spent on a home improvement, can also be used to calculate the Return On Investment (ROI) of a home energy improvement.

### Example 2

### Inefficient HVAC System

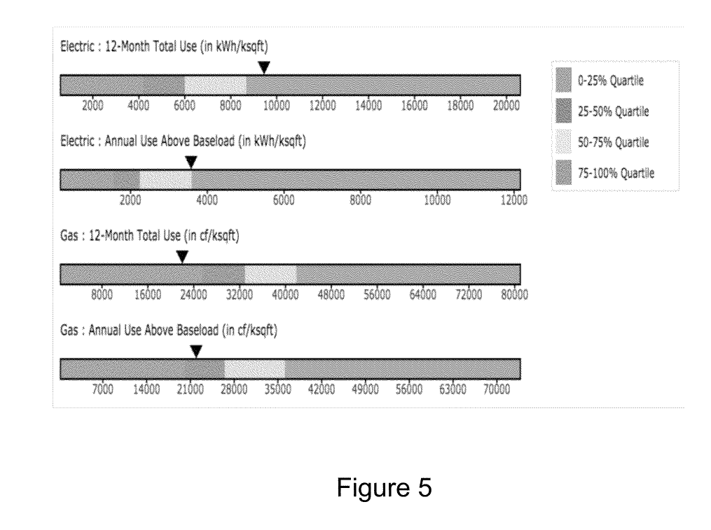

Shown in FIG. 5 is a set of four energy metric histograms for an individual dwelling. The histograms are each constructed by selecting one of many available energy metrics, computing the values for that energy metric amongst other dwellings in a comparison set, plotting all of the resulting data linearly, indicated the positions demarking the quartiles of distribution values in the comparison set, and indicating where on the distribution the particular dwelling subject to evaluation lies.

A given home or dwelling may be characterized by:
A low relative rank compared to similar homes in total electric consumption in units of kWh per square foot per year
A low relative rank compared to similar homes in total electric consumption above baseload in units of kWh per square foot per year
A high relative rank compared to similar homes in total natural gas consumption in units of cubic feet (or therms) per square foot per year
A high relative rank compared to similar homes in total natural gas consumption above baseload in units of cubic feet (or therms) per square foot per year
   The diagnosis for this home is that the HVAC system is operating inefficiently. This is evident by the facts that the home is able to heat efficiently using natural gas, but is not able to cool efficiently using an electric air conditioning system. The precision of the characterization can be increased further by taking into account such variables as the heating and cooling balance point temperatures of the home that are output from the whole-building energy use model. The custom recommendation for such a home would include that the HVAC system may require repair, upgrading or replacement. Other metric ranks based on energy metrics available from the whole-building energy use model that may contribute this diagnosis may include a low relative rank compared to similar homes in kWh per square foot per degree, and a high relative rank compared to similar homes in cubic feet of natural gas per square foot per degree.

### Example 3

### Inefficient Appliances

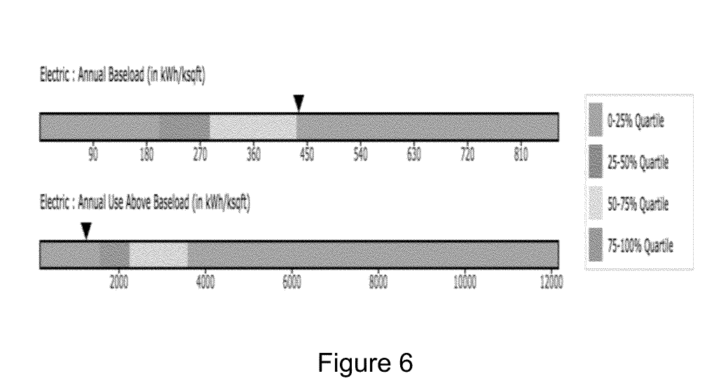

Inefficient electricity use may be the result of the conditions of the HVAC systems, the thermal envelope, the electricity consuming appliances, or another cause. The set of two energy metric histograms for a dwelling shown in FIG. 6 shows the following:
A low relative rank compared to similar homes in annual electric baseload in units of kWh per square foot per year
A high relative rank compared to similar homes in annual electric usage above baseload in units of kWh per square foot per year

The diagnosis for a home having this energy use profile is that there are inefficient electric appliances in the home, such as an old refrigerator or incandescent light bulbs. This is evident by the facts that the home is able to efficiently cool the conditioned space, but that in every month the baseload electric usage is unnecessarily high. Though there are multiple reasons why a home may have regular excessive consumption, a low CV(RMSE) or other relevant metric rankings may indicate that the energy usage of the home is generally predictable. Regular excessive consumption is likely due to appliances requiring an excessive amount of input energy rather than irregular excessive demand for energy services from these appliances. The custom recommendation for such a home would include to replace old appliances with more modern and efficient ones, and to take advantage of available energy efficiency rebates and tax incentives while doing so.

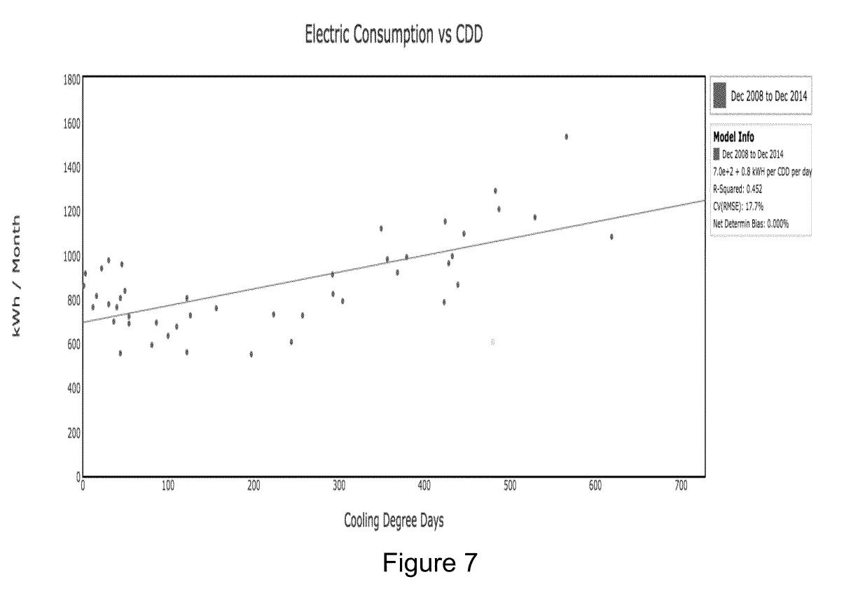

FIG. 7 graphically depicts electric consumption vs. cooling degree days for a home having inefficient appliances. Specifically, FIG. 7 shows electricity consumption vs. CDD with metric outputs from a whole-building energy use model.

### Example 4

### Excessive Waste Heat from Appliances and Electronics

Electric appliances emit waste heat in their usage. Excessive waste heat can be an indicator of unnecessary appliance use, particularly during summer cooling periods, and unnecessary electric heating of predominantly natural gas heated homes. A given home may be characterized by:
A high relative rank compared to similar homes in non-temperature dependent electricity use from the whole-building energy use model
A high relative rank compared to similar homes in temperature dependent electricity use per CDD from the whole-building energy use model
A lower relative rank compared to similar homes in temperature dependent natural use per HDD from the whole-building energy use model than relative rank compared to similar homes in temperature dependent electricity use per CDD
A high relative rank compared to similar natural gas heat homes in the ratio of electric use for heating vs. cooling from the whole-dwelling energy model.

The diagnosis for a home having this energy use profile is that there is excessive waste heat from appliances, electronics and lights. For gas heated homes, there is still an electric heating effect due to the electricity required to run the gas furnace fan motor, additional electric heating elements such as supplemental electric strip heat, or excess heat being generated by incandescent light bulbs or electronics that are left on. The custom recommendation for such a home would include to unplug electronics when not in use, to use the natural gas furnace instead of any strip heat and, depending on other metrics and rankings, to have the gas furnace motor inspected.

With these examples and others, specific sources of inefficient energy use resulting in subtle effects on home energy consumption may require sufficiently high time resolution, long period time series consumption data, and/or large number of peer group comparisons to diagnose.

All publications, patents and patent applications mentioned in this Specification are indicative of the level of skill of those skilled in the art to which this invention pertains and are herein incorporated by reference to the same extent as if each individual publication, patent, or patent application was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for determining at least one source of energy inefficiency of a dwelling, the system comprising:
at least one energy meter for obtaining energy use data for the dwelling;
at least one weather meter for obtaining weather data for the outdoor climate of the dwelling;
a processor for:
(i) calculating at least one energy metric for the dwelling using data obtained from the at least one energy meter and the at least one weather meter, and
(ii) ranking multiple dwellings based on the at least one energy metric,
wherein the ranking of the dwelling based on the at least one energy metric indicates the at least one source of energy inefficiency of the dwelling.

2. The system of claim 1, comprising an energy meter capable of obtaining fuel consumption data and/or electricity consumption data.

3. The system of claim 1, further comprising at least one indoor climate monitor for obtaining indoor climate data.

4. The system of claim 1, wherein the energy use data and/or the weather data is obtained by webscraping.

5. The system of claim 1, wherein the energy metric is an energy use metric.

6. The system of claim 1, wherein the at least one energy meter obtains energy use data monthly, daily or hourly.

7. The system of claim 1, wherein the at least one energy metric is: energy use intensity per unit of conditioned space; temperature dependent energy use; non-temperature dependent energy use; or a combination thereof.

8. The system of claim 1, wherein the at least one energy metric is computed from an energy use model of the dwelling.

9. The system of claim 1, comprising calculating a multitude of energy metrics for the dwelling, and ranking the dwelling along the multitude of energy metrics, and wherein the source of energy inefficiency of the dwelling is calculated using an inverse model.

10. The system of claim 1, further comprising ranking multiple dwellings using at least one physical parameter.

11. The system of claim 1, comprising determining a multitude of sources of energy inefficiency.

12. The system of claim 1, wherein the ranking of similar dwellings using the at least one energy use metric comprises: dwellings in the same zip code, county, state, climate zone or country; dwellings of a comparable interior size or heating method; dwellings within a singular energy efficiency program or utility service area; or a combination thereof.

13. The system of claim 1, wherein the source of energy inefficiency is a heating system, ventilation system, air conditioning system, thermal insulative quality of the structure of the dwelling, air infiltration of the structure of the dwelling, at least one energy consuming appliance within the dwelling, energy consuming behavior of occupants, or a combination thereof.

14. A method for improving the energy efficiency of a dwelling, the method comprising:
obtaining energy use data for the dwelling from at least one energy meter;
obtaining weather data for the outdoor climate of the dwelling from at least one weather meter;
calculating at least one energy metric for the dwelling using data from the at least one energy meter and the at least one weather meter;
ranking the dwelling in a peer group using the at least one energy metric; and
identifying at least one source of energy inefficiency from the ranking.

15. The method of claim 14, further comprising obtaining indoor climate data of the dwelling from at least one indoor climate monitor.

16. The method of claim 14, further comprising making a recommendation to improve the energy efficiency of the dwelling.

17. The method of claim 16, wherein the recommendation to improve the energy efficiency of the dwelling comprises: upgrading dwelling insulation; reducing air infiltration; servicing or replacing an HVAC system; servicing at least one electricity or natural gas consuming appliance; replacing at least one electricity or natural gas consuming appliance; replacing lighting with more energy efficient lighting; changing local landscaping; advising the occupants on means of improving their energy consuming behavior; or a combination thereof.

18. The method of claim 14, comprising obtaining energy data from a plurality of energy meters, wherein the plurality of energy meters are capable of obtaining fuel consumption data, electricity consumption data or both.

19. The method of claim 14, wherein the at least one weather meter comprises a thermometer, barometer, hygrometer, anemometer, rain gauge, snow gauge, or a combination thereof.

20. The method of claim 14, wherein the at least one weather meter obtains data to calculate heating degree days and cooling degree days for the dwelling, and wherein the calculation of heating degree days and cooling degree days is a summation of heating degree hours and cooling degree hours.

21. The method of claim 14, wherein the at least one energy metric is: energy use intensity per unit of conditioned space; temperature dependent energy use; non-temperature dependent energy use; or a combination thereof.

22. The method of claim 14, comprising calculating a multitude of energy metrics for the dwelling, and ranking the dwelling along the multitude of energy metrics, and wherein the source of energy inefficiency of the dwelling is calculated using an inverse model.
